(19) United States
(12) Patent Application Publication
(10) Pub. No.: US 2025/0068315 A1
(43) Pub. Date: Feb. 27, 2025

(54) DISPLAY CONTROL DEVICE, CONTROL METHOD, AND RECORDING MEDIUM

(71) Applicant: CANON KABUSHIKI KAISHA, Tokyo (JP)

(72) Inventor: HAYATO SHIRAI, Kanagawa (JP)

(21) Appl. No.: 18/812,819

(22) Filed: Aug. 22, 2024

(30) Foreign Application Priority Data
Aug. 24, 2023 (JP) 2023-136038

(51) Int. Cl. G06F 3/04845; G06F 3/0482

(52) U.S. Cl. CPC G06F 3/04845; G06F 3/0482

(57) ABSTRACT

A display control device having a plurality of home screens each including a field for performing a predetermined function includes one or more processors and one or more memories, cooperating to control display of a predetermined screen that includes a first field indicating a first home screen included in the plurality of home screens and that is different from the first home screen and to set a background color for each of the plurality of home screens. The first field included in the predetermined screen in a first form when the background color of the first home screen is set to the first form, and the first field included in the predetermined screen in a second form when setting of the background color of the first home screen is changed from the first form to the second form.

### BACKGROUND

### Field

The present disclosure relates to a display control device, a control method, and a recording medium.

### Description of the Related Art

Japanese Patent Laid-Open No. 2020-9047 describes an image forming apparatus that, when a first icon for each of a plurality of applications is placed on a base image having a uniform size or shape, generates a second icon and displays, on a display, an application selection screen on which second icons are arranged.

There is a need for a more convenient user operation on a display control device that displays icons.

### SUMMARY

The present disclosure provides improvement of the user operation on a display control device on which icons are displayed.

According to an aspect of the present disclosure, a display control device having a plurality of home screens each including a field for performing a predetermined function includes one or more processors and one or more memories, cooperating to control display of a predetermined screen that includes a first field indicating a first home screen included in the plurality of home screens and that is different from the first home screen and to set a background color for each of the plurality of home screens. The first field included in the predetermined screen in a first form when the background color of the first home screen is set to the first form, and the first field included in the predetermined screen in a second form when setting of the background color of the first home screen is changed from the first form to the second form.

Further features of the present disclosure will become apparent from the following description of exemplary embodiments with reference to the attached drawings.

### BRIEF DESCRIPTION OF THE DRAWINGS

FIG. 1 is a block diagram schematically illustrating an example of the configuration of a multifunction peripheral (MFP).

FIG. 2 illustrates a standard home screen displayed on an operation panel.

FIGS. 3A to 3C illustrate custom home screens each displayed on the operation panel.

FIG. 4 illustrates a home switching screen displayed on the operation panel.

FIG. 5 illustrates a custom home icon setting screen displayed on the operation panel.

FIG. 6 illustrates a custom home background color setting screen displayed on the operation panel.

FIG. 7 is a flowchart of an icon generation process.

FIG. 8 illustrates a correspondence table between a background color ID and an icon and a correspondence table between a scene icon ID and an icon.

### DESCRIPTION OF THE EMBODIMENTS

The present disclosure is described in detail below with reference to the accompanying drawings. The following example embodiments are in no way intended to limit the present disclosure of the claims. All of the features and the combinations thereof described in the embodiments are not necessarily deemed to be essential to every embodiment of the present disclosure. In the accompanying drawings, identical or similar configurations are identified by the same reference numbers, and redundant descriptions are omitted.

### First Embodiment

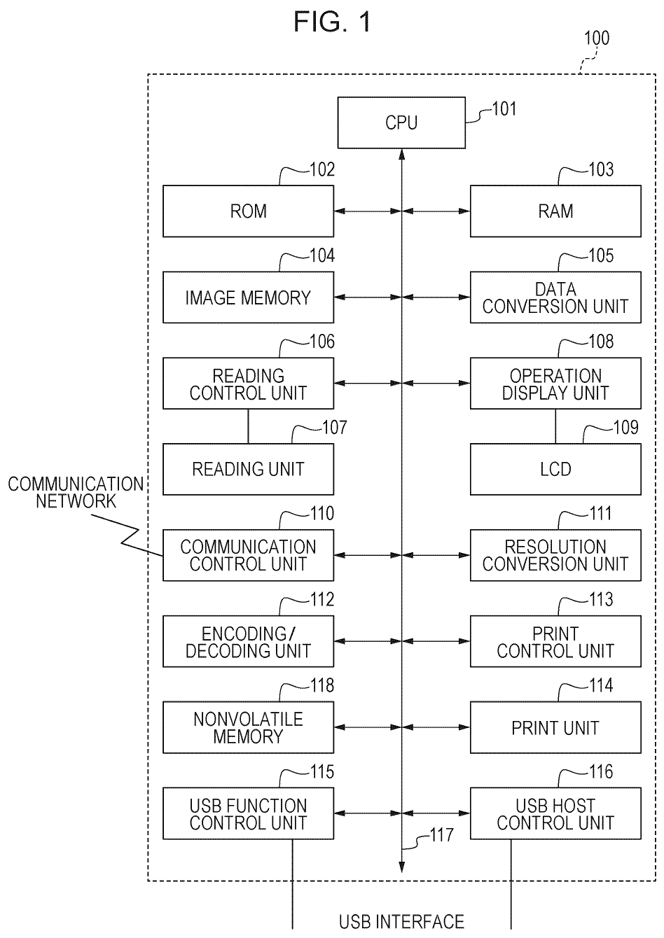

FIG. 1 is a block diagram schematically illustrating an example of the configuration of a multifunction peripheral (MFP) 100, which is a display control device according to the present embodiment. The MFP 100 is one type of information processing apparatus. The MFP 100 is also one type of electronic device. The MFP 100 has information processing functions, such as functions of generating, storing, and transmitting device information including log and status information. The MFP 100 further has an image forming function that forms an image on a recording medium by using a print control unit 113 and a print unit 114 (described below). The method for use of the image forming function may be electrophotographic, inkjet, or any other method.

The display control device according to the present embodiment may be a personal computer (PC), a smartphone, a digital camera, a tablet, or the like.

The MFP 100 includes a central processing unit (CPU) 101, a read only memory (ROM) 102, a random-access memory (RAM) 103, an image memory 104, a data conversion unit 105, a reading control unit 106, a reading unit 107, an operation display unit 108, a liquid crystal display (LCD) 109, a communication control unit 110, and a resolution conversion unit 111. Furthermore, the MFP 100 includes an encoding/decoding unit 112, a print control unit 113, a print unit 114, a USB function control unit 115, a USB host control unit 116, a bus 117 and a nonvolatile memory 118.

The CPU 101 is a system control unit and performs overall control of the MFP 100. The ROM 102 is a nonvolatile memory that stores fixed data, such as a control program, a data table, and an embedded operating system (OS) to be executed by the CPU 101.

According to the present embodiment, each of control programs stored in the ROM 102 is subjected to software execution control, such as scheduling, task switching, and interrupt processing, under the management of the embedded OS stored in the ROM 102. The ROM 102 stores information regarding a permission state indicating whether the device information is provided to the outside. The RAM 103 is composed of a static random-access memory (SRAM) or the like, which requires a backup power supply, and power supply to the RAM 103 is ensured by a primary battery (not illustrated) for data backup. The RAM 103 stores program control variables and the like.

The image memory 104 is composed of a DRAM (dynamic random-access memory) or the like and can accumulate image data. Part of the image memory 104 is reserved as a work area for performing software processes. The data conversion unit 105 can perform image data conversion, such as page description language (PDL) analysis and computer graphics (CG) decompression of character data.

The reading unit 107 optically reads a document with a CIS image sensor and converts the document into an electrical image signal. The reading control unit 106 performs various image processing, such as binarization processing and midtone processing, on the image signals and outputs high-resolution image data. The method for optically reading a document can be either the sheet reading control method, in which a document is read by a CIS image sensor that is fixed, or the book reading control method, in which a document is fixed to the document stand and is read by a CIS image sensor that is moving.

The operation display unit (including the display control unit) 108 can display, for example, a home screen and includes the minimum necessary keys, such as numeric input keys, a mode setting key, a determination key, and a cancel keys, as well as a light emitting diode (LED) and a 7-segment display. The above-described variety of keys are configured as so-called soft keys displayed on the LCD 109, which can accept operations from the user. If no user operation is performed for a certain period of time, the LCD 109 switches the backlight of the LCD 109 to OFF to reduce power consumption. The operation display unit 108 is a display panel (for example, an LCD panel).

The communication control unit 110 controls communication between the MFP 100 and a communication network 300, connects to an Internet service provider, and communicates various data with a service management server 200. The communication control unit 110 can also determine whether the MFP 100 is connected to the Internet or only to a local area network (LAN). The connection between the communication control unit 110 and the communication network 300 is made using HTTP, XMPP, or other widely used techniques. The resolution conversion unit 111 performs resolution conversion processing, such as mutual conversion between millimeter-based image data and inch-based image data.

The resolution conversion unit 111 can also perform enlargement and reduction processing on image data. The encoding/decoding unit 112 performs encoding/decoding processing or enlargement/reduction processing on image data (for example, uncompressed data or MH, MR, MMR, JBIG, or JPEG data) supported by the MFP 100. The print control unit 113 converts the image data to be printed into high-resolution image data by performing various image processing, such as smoothing processing, print density correction processing, and color correction, on the image data to be printed and outputs the image data to the print unit 114. The print control unit 113 also plays a role in periodically acquiring the status information data of the print unit 114. The print unit 114 is, for example, a laser beam printer or an inkjet printer and prints the image data generated by the print control unit 113 on a recording medium, such as printing paper.

The USB function control unit 115 performs protocol control according to the USB communication standard. The USB host control unit 116 is a control unit for communication using the protocol defined in the USB communication standard. The USB communication standard is a standard for bi-directional high-speed data communication. According to the USB communication standard, multiple hubs or functions (slaves) can be connected to one host (master). That is, the USB host control unit 116 provides the host function in USB communication.

The nonvolatile memory 118 is a memory that is nonvolatile and that stores data acquired from the network and the settings of the information processing apparatus. The configurations other than the reading unit 107 and the LCD 109 are connected with one another via a bus 117. The operation display unit 108 has a screen by which the home screens can be switched.

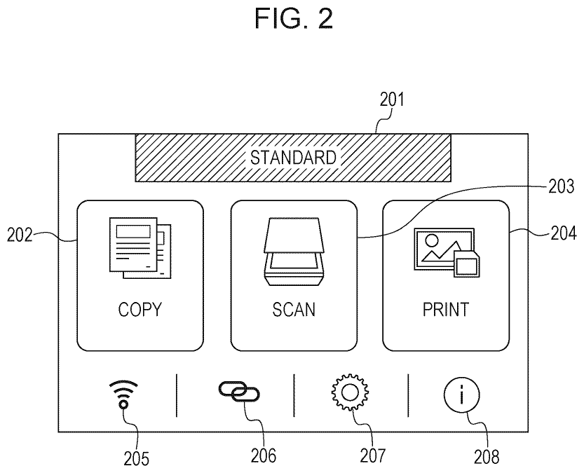

FIG. 2 illustrates a standard home screen displayed on the operation display unit 108 of the MFP 100.

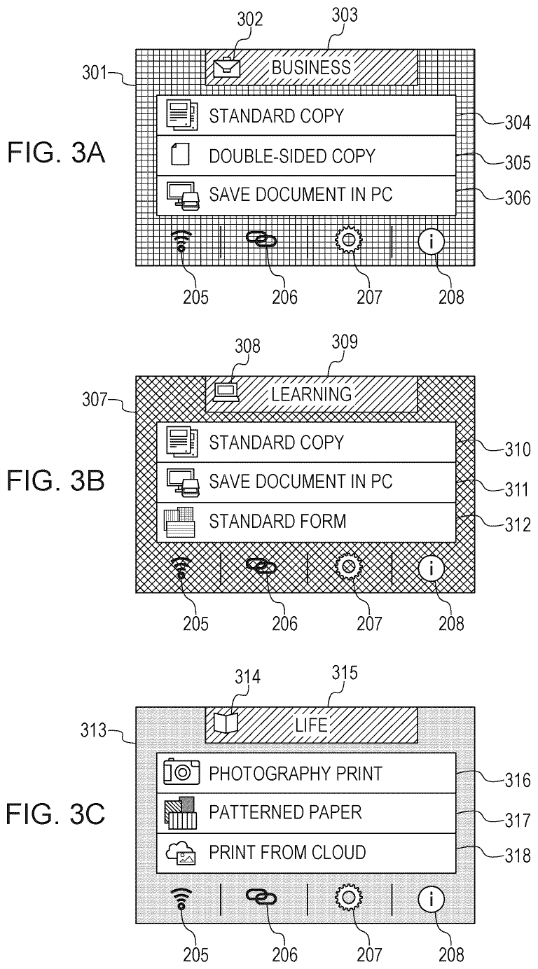

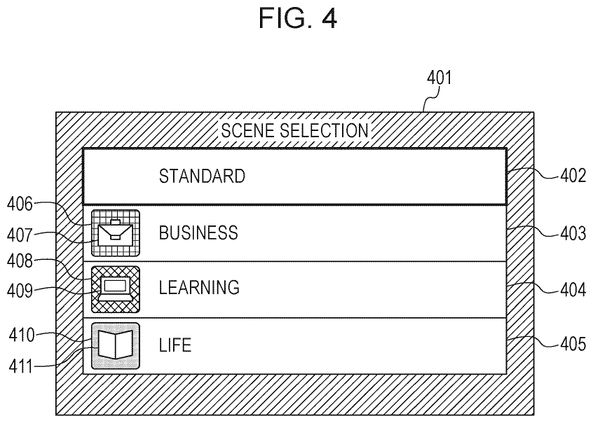

The standard home screen is a main menu screen. The field of a button 201 displays information indicating that the screen is the standard home screen, and the button 201 is a home switching button for displaying a home switching screen corresponding to a screen 401 illustrated in FIG. 4 (described below). The home switching screen allows switching among the standard home screen corresponding to a screen illustrated in FIG. 2 and the custom home screens (custom menu screens) corresponding to screens 301, 307, and 313 illustrated in FIGS. 3A, 3B, and 3C, respectively. The custom home screen is a sub-menu screen, and multiple custom home screens are provided depending on the scene of use. The user can select a scene displayed in the home switching screen to switch among home screens, and the custom home screen is selectively displayed on the operation display unit 108. On the screen illustrated in FIG. 2, a copy menu button 202 corresponds to the copy function. If the pressing of the copy menu button 202 is detected, the screen transitions to a copy menu screen. A scan menu button 203 corresponds to the scan function. If the pressing of the scan menu button 203 is detected, the screen transitions to the scan menu screen. A print menu button 204 corresponds to the print function. If the pressing of the print menu button 204 is detected, the screen transitions to a print menu screen. A LAN button 205 corresponds to LAN settings. If the pressing of the LAN button 205 is detected, the screen transitions to a LAN settings screen. A wireless connect button 206 corresponds to wireless connect. If the pressing of the button 206 is detected, the screen transitions to a wireless connect start screen. A printer setting button 207 corresponds to printer settings. If the pressing of the printer setting button 207 is detected, the screen transitions to a printer settings screen. A tips button 208 is a button corresponding to tips. If the pressing of the tips button 208 is detected, the screen transitions to a tips screen.

As used herein, the term “home screen” refers to a screen on which one of a plurality of functions can be selected. For example, the home screen is an operation screen that is first displayed after the image processing unit is powered on.

FIGS. 3A to 3C illustrate custom home screens displayed on the operation panel.

Custom menus 304, 305, 306, 310, 311, 312, 316, 317, and 318 are user-customizable menus, allowing the user to specify the functions to be displayed at the menu locations. Scene icons 302, 308, and 314 are user-customizable icons, and the user can specify which icon to display in each of the custom home screens. Each of the first custom screen 301, the second custom screen 307, and the third custom screen 313 can be categorized in accordance with a specific use or user. The first custom screen 301 is categorized for business use, the second custom screen 307 for learning use, and the third custom screen 313 for life use, and menus frequently used for each use can be disposed in the corresponding home screens. The buttons 303, 309, and 315 are fields where information indicating the scene of the displayed home screen is displayed. If each of the buttons 303, 309, and 315 is pressed, the home switching screen illustrated in FIG. 4 (described below) is displayed. The background color of each of the first custom screen 301, the second custom screen 307, and the third custom screen 313 can be customized by the user, and the user can specify the background color of the custom home screen. A “Home” button (not illustrated) is a button for displaying a home screen corresponding to a home menu selected in the home switching screen in FIG. 4 (described below). For example, when a menu is selected in a certain home screen and, thus, the certain home screen transitions to a screen different from the certain home screen, the home button is used to display the certain home screen again. When the pressing of the home button is detected, the home screen corresponding to the home menu selected in the home switching screen illustrated in FIG. 4 (described below) is displayed. The home button may be a software key displayed on the operation display unit 108 or a hardware key provided on the MFP 100.

FIG. 3A illustrates a custom home screen with menus frequently used in the business scene disposed on the home screen. The first custom screen 301 is a custom home screen for a business scene. The custom menu 304 is a button corresponding to a standard copy function, the custom menu 305 is a button corresponding to a double-sided copy function, and the custom menu 306 is a button corresponding to a function to save a document in a personal computer (PC). When the pressing of each of the buttons is detected, the screen transitions to the corresponding function setting screen.

FIG. 3B is a custom home screen with menus frequently used in the learning scene disposed in the home screen. The second custom screen 307 is a custom home screen for a learning scene. The custom menu 310 is a button corresponding to the standard copy function, the custom menu 311 is a button corresponding to a function to save a document to a PC, and the custom menu 312 is a button corresponding to a standard form function. When the pressing of each of the buttons is detected, the screen transitions to the corresponding function setting screen.

FIG. 3C is a custom home screen with menus frequently used in a life scene disposed on the home screen. The third custom screen 313 is a custom home screen for a life scene. The custom menu 316 is a button corresponding to a photography printing function, the custom menu 317 is a button corresponding to the patterned paper function, and the custom menu 318 is a button corresponding to a function to print from a cloud. When the pressing of each of the buttons is detected, the screen transitions to the corresponding function setting screen.

The icon for a function, such as the standard copy displayed in each of the scenes, may be predetermined from the time of factory shipping or may be configured so as to be changeable by the user.

FIG. 4 illustrates the home switching screen (a scene selection screen) for setting the home screen to be displayed on the operation panel. When one of the home menus 402, 403, 404, and 405 is selected, the home screen corresponding to the selected home menu is displayed. That is, the user can switch the screen to the home screen corresponding to the scene to be used by selecting one of the home menus 402, 403, 404, and 405. The predetermined icon corresponding to each of the home menus consist of a custom icon corresponding to the home menu and a background icon representing the background color of the custom icon. When power is supplied to the MFP 100 and, then, the soft power-on operation is performed, the home screen that was previously set immediately before soft power-off of the MFP 100 is displayed. When the above-described home button (not illustrated) is pressed, the home screen that had been set is displayed.

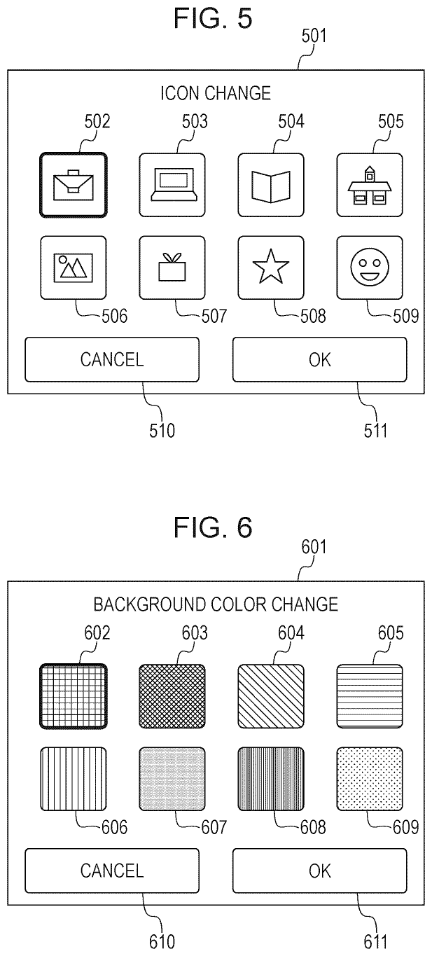

A screen 501 illustrated in FIG. 5 is an icon setting screen for setting a scene icon to be displayed on a custom home screen. When one of scene icons 502, 503, 504, 505, 506, 507, 508, and 509 is selected and, then, an OK button 511 is pressed by the user, a scene icon corresponding to a certain custom home screen is set. If a cancel button 510 is pressed, the screen 501 is closed.

A screen 601 illustrated in FIG. 6 is a background color setting screen for setting the color of the background (the background color) to be displayed on the custom home screen. The user can set the background color of the custom home screen by selecting one of background colors 602, 603, 604, 605, 606, 607, 608, and 609 and, then, pressing an OK button 611. Note that although the background colors 602, 603, 604, 605, 606, 607, 608, and 609 in FIG. 6 have different patterns to help illustrate the difference, they can have different colors without the patterns. As illustrated in FIG. 6, as the background to be displayed on a custom home screen, a background image with a pattern in addition to a color may be selected.

Each of the icon setting screen in FIG. 5 and the setting screen in FIG. 6 for setting a background color displayed on the custom home screen is displayed when the printer setting button 207 in each of the custom home screens is pressed and, then, a button to display the corresponding setting screen is pressed.

If the background color set for each of the custom home screens is different from the color of the background icon of the home menu corresponding to the custom home screen on the home switching screen, it is difficult for the user to determine which home menu with an icon to select to reach the desired custom home screen, which reduces the usability. For this reason, the user may select a home menu corresponding to a different custom home screen than the desired custom home screen on the home switching screen.

In addition, if the scene icon set for each of the custom home screens is different from a predetermined custom icon corresponding to the custom home screen on the home switching screen, it is somewhat difficult for the user to determine which home menu item with an icon to select to reach the desired custom home screen, which reduces the usability. For this reason, the user may select a home menu corresponding to a different custom home screen than the desired custom home screen on the home switching screen.

Therefore, according to the present embodiment, a technique is described for generating a home menu icon corresponding to each of the custom home screens to be displayed on the home switching screen on the basis of the background color set for each of the custom home screens and icon information. That is, the color of the home menu icon corresponding to a certain custom home screen on the home switching screen is made to be the same as the background color of the certain custom home screen. In addition, the custom icon of the home menu corresponding to a certain custom home screen on the home switching screen is made to be the same as the scene icon of the certain custom home screen. This makes it easier to select the home menu corresponding to the custom home screen on the home switching screen, thus improving the usability.

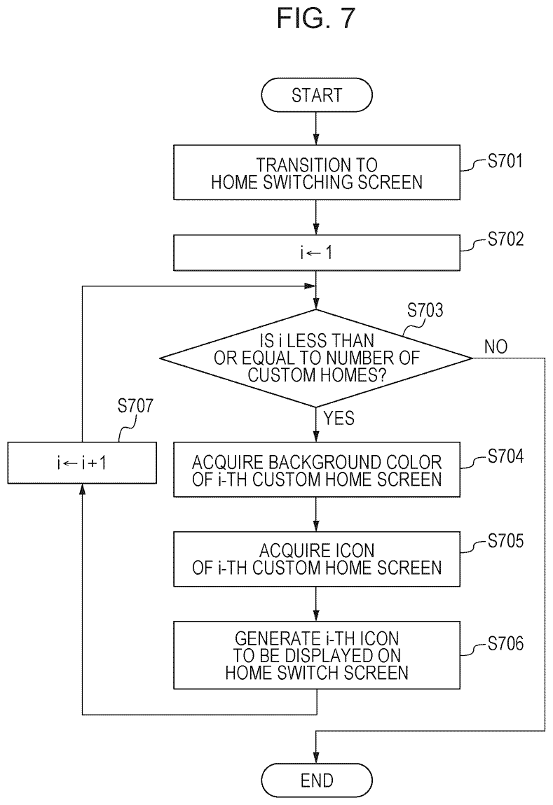

FIG. 7 is a flowchart of the process of generating icons to be displayed on the home switching screen illustrated in FIG. 4. The series of processes illustrated in FIG. 7 is performed by the CPU 101 of the MFP 100 loading program code stored in the ROM 102 into the RAM 103 and executing the program code. Alternatively, some or all of the functions of the steps in FIG. 7 may be realized by hardware, such as an ASIC or electronic circuit. The symbol “S” used in description of each of the processes in the flowchart stands for step.

In S701, upon detecting the pressing of the home switching button, the CPU 101 changes a screen to the home switching screen. More specifically, the CPU 101 displays the screen 401 illustrated in FIG. 4.

In S702, the CPU 101 initializes a custom home number i to 1. The custom home number i is a number that indicates each of the custom home screen and the home menu corresponding to the custom home screen. According to the present embodiment, the custom home number i for the custom home screen for business use is 1, the custom home number i for the custom home screen for learning use is 2, and the custom home number i for the custom home screen for life use is 3. However, the custom home numbers corresponding to the custom home screens are not limited thereto.

In S703, the CPU 101 determines whether the custom home number i is less than or equal to the number of custom homes. If it is determined that the custom home number i is not less than or equal to the number of custom homes (if the determination is NO), the processing of the flowchart ends. If it is determined that the custom home number i is less than or equal to the number of custom homes (if the determination is YES), the processing proceeds to S704.

In S704, the CPU 101 acquires the background color of the i-th home menu. The background color is the background color set on the screen 601 illustrated in FIG. 6.

In S705, the CPU 101 acquires the scene icon of the i-th custom home screen. The icon is the icon set on the screen 501 illustrated in FIG. 5.

In S706, the CPU 101 generates the i-th icon to be displayed on the home switching screen illustrated as the screen 401 in FIG. 4.

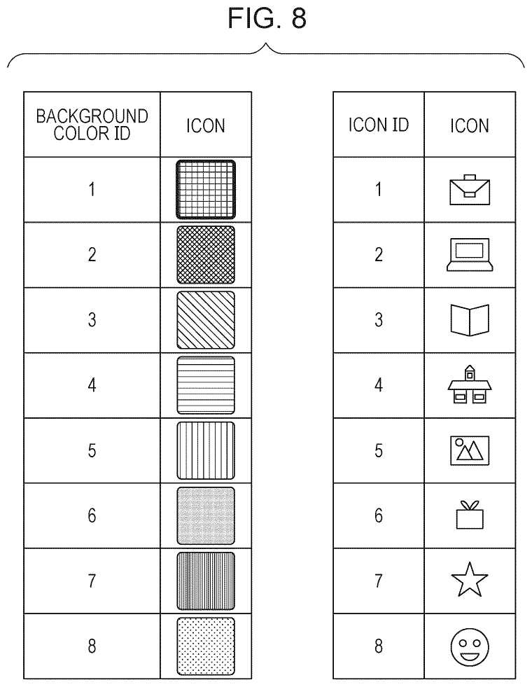

FIG. 8 illustrates a correspondence table between a background color ID and an icon and a correspondence table between an icon ID and an icon.

Generation of an icon illustrated in FIG. 7 is described below with reference to the corresponding tables illustrated in FIG. 8. As an example, the case is described where the icon (410, 411) of the home menu 405 corresponding to the custom home screen for “Life” (the custom home number i is 3, the background color ID is 6, and the icon ID is 3) is generated in the screen 401 in FIG. 4. In S704, the CPU 101 acquires the background color of the custom home screen for “Life” use (the background color having a background color of 6) illustrated in FIG. 3C. In S705, the CPU 101 acquires the scene icon of the custom home screen for “Life” use illustrated in FIG. 3C (the icon having an icon ID of 3). In S706, the CPU 101 generates an icon from the icon (410, 411) of the home menu 405 on the screen 401 illustrated in FIG. 4 on the basis of the background color based on the background color ID acquired in S704 and the icon based on the icon ID acquired in S705. That is, the background color of the custom home screen for “Life” use illustrated in FIG. 3C is the same as the color of the icon 410, and the scene icon 314 of the custom home screen for “Life” use illustrated in FIG. 3C is the same as the icon 411. The icons of the home menus corresponding to other custom home screens are generated in the same way.

In S707, the CPU 101 increments the value of the custom home number i and returns to S703.

The embodiment in which the custom home number is initialized to 1 in S702 has been described above. However, the embodiment is not limited thereto. The same result as that in the flowchart illustrated in FIG. 7 can be obtained by initializing the custom home number i to the largest number of custom home screens in S702 and, thereafter, repeating the process while decrementing the custom home number i in S707.

In the description of the embodiment above, the icon of a home menu corresponding to each of the custom home screens displayed on the home switching screen is generated on the basis of the background color and icon information set for each of the custom home screens. This enables the color of the home menu icon corresponding to each of the custom home screens to be the same as the background color of the custom home screen. This makes it easier to select the home menu corresponding to the custom home screen on the custom home screen, thus improving the usability.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-136038 filed Aug. 24, 2023, which is hereby incorporated by reference herein in its entirety.

What is claimed is:

1. A display control device having a plurality of home screens each including a field for performing a predetermined function, the display control device comprising:
one or more processors and one or more memories, cooperating to:
control display of a predetermined screen that includes a first field indicating a first home screen included in the plurality of home screens and that is different from the first home screen; and
set a background color for each of the plurality of home screens,
wherein the first field included in the predetermined screen in a first form when the background color of the first home screen is set to the first form, and
wherein the first field included in the predetermined screen in a second form when setting of the background color of the first home screen is changed from the first form to the second form.

2. The display control device according to claim 1, wherein the predetermined screen is a screen including a plurality of fields each indicating one of the plurality of home screens.

3. The display control device according to claim 1, wherein the predetermined screen is a selection screen for selecting any one of the plurality of home screens.

4. The display control device according to claim 3, wherein the one or more processors and the one or more memories further cooperating to control display of any one of the home screens that is selected on the selection screen.

5. The display control device according to claim 1, wherein the first field is a field for selecting the first home screen from among the plurality of home screens.

6. The display control device according to claim 1, wherein the first field is a field for displaying the first home screen among the plurality of home screens.

7. The display control device according to claim 1, wherein the first field is a soft key indicating the first home screen.

8. The display control device according to claim 1, wherein the first field has a color of the background color of an icon representing the first home screen.

9. The display control device according to claim 1, wherein the one or more processors and one or more memories further cooperating to control display of the first field included in the predetermined screen in a first form if the background color of the first home screen is set to the first form and an instruction to display the predetermined screen is received, and
wherein the one or more processors and one or more memories further cooperating to control display of the first field included in the predetermined screen in a second form if setting of the background color of the first home screen is changed from the first form to the second form by the setting unit and an instruction to display the predetermined screen is received.

10. The display control device according to claim 1, wherein a field for displaying the predetermined screen is displayed in the predetermined field of the first home screen.

11. The display control device according to claim 10, wherein information indicating the first home screen is displayed in the field for displaying the predetermined screen.

12. The display control device according to claim 11, wherein the information indicating the first home screen includes a name of the first home screen and an icon representing the first home screen.

13. The display control device according to claim 1, wherein the field for performing a predetermined function is one of a field for performing a print function and a field for performing a scan function.

14. The display control device according to claim 1, wherein the one or more processors and the one or more memories further cooperating to:
set icons each representing one of the plurality of home screens.

15. A method for controlling a display control device having a plurality of home screens each including a field for performing a predetermined function, the method comprising:
displaying a predetermined screen that includes a first field indicating a first home screen included in the plurality of home screens and that is different from the first home screen; and
setting a background color for each of the plurality of home screens,
wherein in displaying, the first field included in the predetermined screen is displayed in a first form if the background color of the first home screen is set to the first form, and the first field included in the predetermined screen is displayed in a second form if setting of the background color of the first home screen is changed from the first form to the second form in setting a background color.

16. A non-transitory computer-readable recording medium storing one or more control programs including executable instructions, which when executed by a computer of a display control device having a plurality of home screens each including a field for performing a predetermined function, cause the computer to perform a method comprising:
displaying a predetermined screen that includes a first field indicating a first home screen included in the plurality of home screens and that is different from the first home screen; and
setting a background color for each of the plurality of home screens,
wherein in displaying, the first field included in the predetermined screen is displayed in a first form if the background color of the first home screen is set to the first form, and the first field included in the predetermined screen is displayed in a second form if setting of the background color of the first home screen is changed from the first form to the second form in setting a background color.
